(19) United States
(12) Patent Application Publication
(10) Pub. No.: US 2008/0254165 A1
(43) Pub. Date: Oct. 16, 2008

(54) Novel manufacturing process for milk acid

(76) Inventors: Rashid Patel, (US); Matthew Sandry, (US); Richard Seguin, Amarillo, TX (US)

Correspondence Address: INTEGRATED DAIRY TECHNOLOGIES, 16 LAFAYETTE LOOP, ROSWELL, NM, 88201-5269, US

(21) Appl. No.: 11/627,278

(22) Filed: Apr. 12, 2007

(51) Int. Cl. A23C 9/12

(52) U.S. Cl. 426/40

(57) ABSTRACT

The process consists of manufacturing milk acid from milk sugar by lactic fermentation process. The milk sugar is obtained as permeate from ultra-filtration of milk or from cheese or casein whey both in liquid, concentrate or dry form. The milk acid is separated and purified by a combination of membrane technology i.e., ultra-filtration/micro-filtration and nano-filtration. The purified milk acid is concentrated by evaporation, distillation or reverse osmosis.

### SUMMARY OF INVENTION

this application is for a novel manufacturing procedure for manufacturing milk acid from milk permeates.

### FIELD OF THE INVENTION

this invention relates to separating components from milk permeate or whey and then fermenting the milk permeate or whey permeates by naturally occurring milk bacteria.

### BACKGROUND OF THE INVENTION

Utilization of wastes of any industry is a big service to human beings by preventing environmental pollution and indirectly helping the human health. Dairy Industry is one of the most important food industries and helps human health by providing lot of nutrition. The advancement of technology and nutritional needs has been continuously changing the main products and by-products from milk. The development of cream separator in late nineteenth century resulted in separation of milk into skim milk and cream. Cream was then considered to be the main product and skim milk as a waste or by product. Skim milk was mostly used for animal feed. With the advancement of nutritional sciences, the role of fat in nutrition became less important. The role of protein enhanced and skim milk and other products became main products. There are several commercial processes by which individual components of milk are separated and then transported as per requirements in the human needs directly in the form of retail food or indirectly as ingredients for other industries. The concentration or separation of milk components near or in the production centers resulted in different types of wastes or by-products. For example; Skim milk was initially considered a waste by-product but is now an important nutrient for humans. The permeates of milk due to on farm concentration, separation or cheese manufacture do contain very healthy nutritive components both for humans and animals and are not widely recuperated due to economic costs. These wastes can result in the pollution of streams, rivers, wetlands, and the earth's surface creating environmental problems. Permeates of milk do contain nutrients for bacteria and therefore, the under utilization of milk permeate stream may result in health hazards.

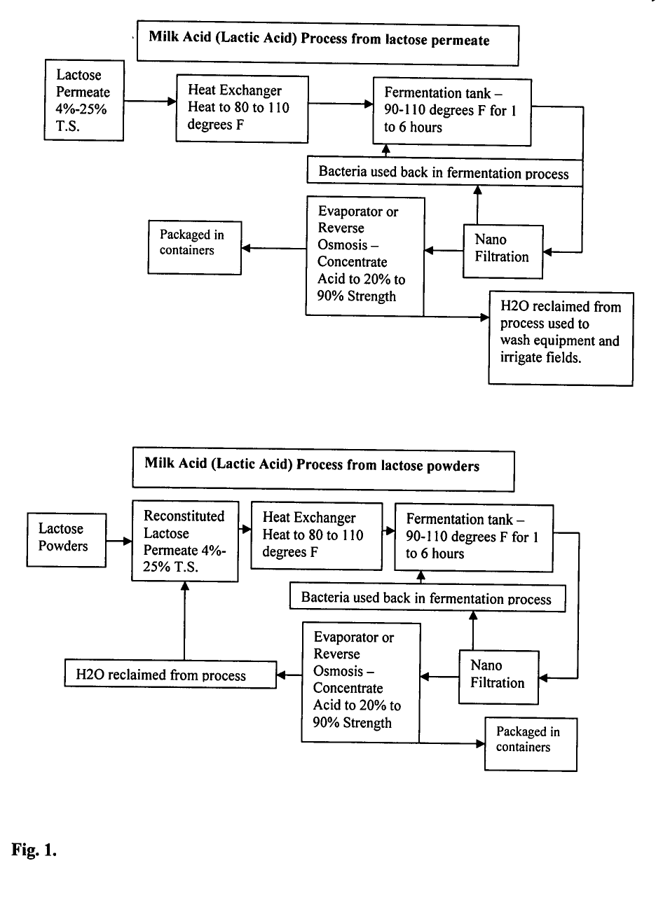

in the present invention an attempt has been made to manufacture milk acid from a milk sugar called lactose (see FIG. 1). The milk acid is referred as lactic acid as it has its origins from milk sugar. Lactose is the main components of most of the dairy permeates like cheese whey or permeate obtained by concentrating milk proteins by membrane technology. Any positive utilization of lactose will help the milk producers as well as the Dairy Industry as a whole. The milk producers will get a better price for their products and the community will have a cleaner environment.

Milk acid is an important constituent for many foods and also has many industrial uses. The demand for lactic acid is increasing world wide and the production capacity is stagnant. Manufacturing lactic acid by natural process would be highly beneficial to humans

Milk when kept at ambient temperature turns sour due to action of lactic acid bacteria on milk sugar resulting in acidified milk, the controlled acid production results in range of cultured dairy products like yoghurt, kefir, sour cream, cheese, butter milk etc. The health benefits of cultured dairy products which owe their existence to production to lactic acid are well known.

Lactic acid or milk acid is a three carbon organic acid containing one alcohol and one carboxylic group. Lactic acid exists in two optically active isomers, i.e., L(+) lactic acid and D(−) lactic acid due to position of alcoholic group on the central carbon atom.

Commercially lactic acid is produced by two processes, a chemical synthetic process in which hydrogen cyanide is added to acetaldehyde in presence of a base to produce lacto-nitrile. This crude lactonitrile is then purified by distillation followed by its acid (hydrochloric or sulfuric) hydrolysis to lactic acid. The chemical synthetic method results in a racemic mixture of lactic acid. The other process for manufacturing lactic acid is by fermentation of carbohydrate (mostly glucose from corn/molasses). The fermentation process is very specific which allows the manufacturer to either make L or D form of lactic acid by selecting a specific strain of lactic acid bacteria or yeast. The traditional process of manufacturing lactic acid consists of fermenting carbohydrate by specific LAB followed by filtration to remove cells followed by evaporation, purification and hydrolysis. The traditional process is time consuming and the yields are poor. The bacterial cells in the traditional lactic acid process are not regenerated during the fermentation process and get killed.

in the current process, whole or skim milk are separated by ultrafiltration to get a lactose rich permeate and protein rich retentate. In certain examples, the UF permeate is directly used for lactic acid manufacture. However, in order to make the process efficient the UF permeate is concentrated and purified by nanofiltration/loose reverse osmosis before fermentation. The NF concentrate with 14-25% solids is warmed to 30-44° C. followed by inoculation with selected strains of LAB (Lactobacillus bulgaricus, Streptococcus thermopiles, Lactobacillus acidophilus, Lactococcus lactis subs cremoris, Lactococcus lactis subs lactis) or yeasts (Kleveromyces lactis).

the warm inoculated lactose concentrate is again passed through NF membranes. The bacterial cells, un-fermented lactose, proteins and materials get retained on the surface while the pure dilute stream of lactic acid passes the membranes. The continual removal of lactic acid helps the bacteria to continue growing and fermenting the remaining unfermented lactose. This process helps to completely ferment lactose into lactic acid and therefore maximize the yields.

the lactic acid stream is further concentrated by reverse osmosis, evaporation, distillation or by centrifugation to more than 50-90% concentration before packaging into retail containers.

the starting material for lactic acid manufacture in some other cases can be milk whey obtained from cheese or casein manufacture.

in some modifications of the process, commercial lactose powder or milk permeate powder is reconstituted with water and used as a base material for lactic acid manufacture.

the retetate stream of NF is used as a bacterial inoculums for further batches. Bacterial cells separated from the NF retentate by ultrafiltration process. The UF retentate contains only bacteria while permeate contains low molecular weight proteinous material and minerals. The permeate of UF is further concentrated by reverse osmosis and used as feed for growing bacteria.

the waste stream of the lactic acid manufacturing process is water re-cycled several times. (Could be used to reconstitute lactose powders)

### WORKING EXAMPLES

### Example 1

In an embodiment of the invention, UF-permeate of skim milk at 45-50 C was passed through a nan-ofiltration module to remove 50% of the minerals present in the UF permeate along with 75% water. The NF retentate contains 15-19% lactose on weight by volume basis. After getting the desired concentration of lactose in NF retentate, it was inoculated with direct vat type of a mixed culture containing Lactobacillus bulgaricus and Streptococcus thermophilus. Once lactic acid started accumulating, the nanofiltration process was started again confirmed by measuring pH of the retentate. The permeate containing 0.8-1.2% lactic acid was concentrated by evaporation to 50-90% strength of acid

### Lactic Acid Manufacture Process from Lactose Permeate

Lactose (molecular weight=342) was converted into lactic acid (molecular weight=90) by fermentation of UF-milk permeate or cheese whey. 1 molecule of lactose should gives at-least two molecules of lactic acid.

### Example 2

Process from UF-Permeate
1. UF-permeate (5% lactose) in a silo/fermentor (with special agitators)
2. Warmed to 38-40° C.
3. Added bacterial culture containing Lactobacillus bulgaricus (90 g/L) and Streptococcus thermophilus and Lactococus lactis sub cremoris in order to get fast fermentation (3-4 hours) in the silo.
4. After 1 hour inoculation with bacterial culture started nano-filtration (NF) of the mixture in silo.
5. The lactic acid produced in the process was be removed in the permeate of NF which will prevent the killing of bacterial cultures and therefore, cultures continued to produce lactic acid from lactose at a constant rate.
6. The retentate of NF— was a bacterial culture which can be re-used and will make the process economical.
7. The permeate of NF was dilute solution of lactic acid.
8. The dilute lactic acid solution was concentrated by reverse osmosis, evaporation, distillation or by centrifugation, to any desired strength.
9. A UF-permeate containing 5% lactose (50,000 lbs) should give at-least 45000 lbs of lactic acid containing a strength of 6-7%.
10. The conversion factor for Lb. bulgaricus is 99%. i.e 99% lactose will be converted to lactic acid and the other 1% will be converted by other lactic acid bacteria.

1. A process for manufacture of lactic acid has been developed in which source of milk sugar lactose is either permeate of skim milk obtained during ultrafiltration of skim milk or whey obtained during cheese manufacture from milk or whey obtained during casein manufacture from skim milk.

2. Lactose or permeate powder is re-constituted to a solution containing 10-40% lactose followed by fermentation of lactose to lactic acid.

3. Lactic acid is purified by membrane technology using combination of nanofiltration and ultrafiltration.

4. The fermentation of lactose to lactic acid and removal of lactic acid during the process is a continuous process.

5. The process described in this invention can be used for manufacture of propionic acid, acetic acid, citric acid etc by choosing different strains of bacteria
